(19) United States
(12) Patent Application Publication
(10) Pub. No.: US 2008/0006673 A1
(43) Pub. Date: Jan. 10, 2008

(54) Fastener feeding device for stapler

(76) Inventor: Chi Cheng Chou, (US)

Correspondence Address: CHARLES E. BAXLEY, ESQ., 90 JOHN STREET, THIRD FLOOR, NEW YORK, NY, 10038, US

(21) Appl. No.: 11/388,953

(22) Filed: Dec. 28, 2005

(51) Int. Cl. B25C 5/06

(52) U.S. Cl. 227/137; 227/120

(57) ABSTRACT

A stapler includes a housing having a port for coupling to a pressurized reservoir and a casing attached to a nose piece and having a guide channel for guiding fasteners toward the nose piece. A gripping and feeding device includes a pair of arms having one end for gripping and feeding the fasteners toward the nose piece step by step. The arms each includes a shoe for engaging with the fasteners, and a holder for holding and supporting the shoe. An actuating device is slidably engaged with the arms, the actuating device includes two actuators for selectively moving the arms away from each other, and two blocks for selectively moving the arms toward each other.

### BACKGROUND OF THE INVENTION

1. Field of the Invention

The present invention relates to a fastener feeding device for a stapler, and more particularly to a fastener feeding device for engaging with and for feeding staples or nails or fasteners of the stapler step by step or one by one and for allowing the staples or nails or screws or bolts or various fasteners to be effectively driven or hammered by the stapler.

2. Description of the Prior Art

Typical staplers or fastener driving devices comprise a spring member or a spring-biased pusher slidably disposed therein for engaging with and for biasing staples or nails or fasteners of the stapler forwardly toward a driver or hammering piece, and for allowing the staples or nails or fasteners to be driven or hammered by the driver or hammering piece of the stapler.

However, the spring member or the spring-biased pusher is only good for pushing and forcing the typical U-shaped or T-shaped nails that are solidly coupled together and disposed closely side by side, but may not be used for pushing and forcing the typical nails or screws having rounded shanks or stems.

For example, U.S. Pat. No. 5,975,350 to Han discloses one of the typical screw feeding apparatuses including a spring-biased platform slidably disposed in nail casing or magazine for engaging with and for moving the nails or fasteners forwardly toward the nail driver or hammering piece. However, the spring-biased platform also may not be used for pushing and forcing the typical nails or screws having rounded shanks or stems.

U.S. Pat. No. 6,227,429 to Huang discloses another typical screw feeding device including a spring-biased pusher having an extension for engaging with and for moving the nails or fasteners forwardly toward the nail driver or hammering piece. However, the extension of the spring-biased pusher may be engaged with the other nails or fasteners inadvertently when the spring-biased pusher is moved relative to the nails or fasteners.

The present invention has arisen to mitigate and/or obviate the afore-described disadvantages of the conventional fastener feeding devices for staplers.

### SUMMARY OF THE INVENTION

The primary objective of the present invention is to provide a fastener feeding device for engaging with and for feeding staples or nails or fasteners of the stapler step by step or one by one and for allowing the staples or nails or screws or bolts or various fasteners to be effectively driven or hammered by the stapler.

In accordance with one aspect of the invention, there is provided a stapler comprising a housing including a port for coupling to a pressurized reservoir, and including a nose piece attached thereto, a casing attached to the nose piece and including a guide channel formed therein for receiving and for guiding fasteners toward the nose piece, and a gripping and feeding device for gripping and feeding the fasteners toward the nose piece step by step.

The gripping and feeding device includes a pair of arms having a first end for engaging with the fasteners and for gripping the fasteners. The arms each includes a shoe attached to the first end thereof for engaging with the fasteners. The arms each includes a holder attached the first end thereof for holding and supporting the shoe.

The holders are each pivotally attached to the arms respectively with a pivot pin. The casing includes an opening formed therein and communicating with the guide channel thereof for receiving the shoes of the arms and for allowing the shoes to selectively move toward the fasteners.

The gripping and feeding device includes an actuating device slidably engaged with the arms for selectively moving the first ends of the arms toward each other and for selectively moving the first ends of the arms away from each other. The actuating device includes two actuators extended therefrom for engaging with the arms for selectively moving the first ends of the arms away from each other. The arms each includes a bulge extended therefrom for engaging with the actuators respectively.

The actuating device includes two blocks extended therefrom for engaging with the arms for selectively moving the first ends of the arms toward each other. The actuating device includes a longitudinal lever having a beam extended therefrom and having the blocks extended from the beam for engaging with the arms. The blocks each includes an inclined surface formed therein for engaging with the arms. The arms each includes a swelling extended therefrom for engaging with the blocks respectively.

The gripping and feeding device includes a cylinder having a piston slidably received therein and coupled to the actuating device for moving the actuating device relative to the arms. The cylinder includes a post attached thereto, the arms each includes a second end pivotally attached to the post. The arms each includes a bent end panel formed in the second end thereof and pivotally attached to the post, and a spacer disposed between the end panels of the arms to space the end panels of the arms from each other.

The casing includes a cover pivotally attached thereto with a pivot axle for selectively opening and enclosing the guide channel of the casing. The cover includes a spring-biased latch for selectively locking the cover to the casing. The cover includes a retainer attached thereto for slidably attaching the latch, and a peg attached thereto, and a spring member disposed between the latch and the peg for biasing a tongue of the latch to selectively engage with a stop.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a stapler having a fastener feeding device in accordance with the present invention;

FIG. 2 is a partial exploded view of the fastener feeding device for the stapler;

FIG. 3 is a side plan view of the stapler and the fastener feeding device;

FIG. 4 is an enlarged partial side plan view of the fastener feeding device of the stapler;

FIG. 5 is an enlarged partial side plan view similar to FIG. 4, illustrating the operation of the fastener feeding device for the stapler;

FIG. 6 is a partial cross sectional view taken along lines 6-6 of FIG. 4;

FIG. 7 is a partial cross sectional view similar to FIG. 6, illustrating the operation of the fastener feeding device for the stapler;

FIG. 8 is a partial cross sectional view taken along lines 8-8 of FIG. 4;

FIG. 9 is a partial cross sectional view similar to FIG. 8, illustrating the operation of the fastener feeding device for the stapler;

FIGS. 10, 11 are partial exploded views illustrating the fastener gripping device for the stapler;

FIG. 12 is a partial cross sectional view taken along lines 12-12 of FIG. 4;

FIG. 13 is a partial cross sectional view similar to FIG. 12, illustrating the operation of the fastener feeding device for the stapler;

FIG. 14 is a further enlarged partial side plan view of the fastener feeding device of the stapler;

FIG. 15 is a still further enlarged partial side plan view similar to FIG. 14, illustrating the operation of the fastener feeding device for the stapler;

FIG. 16 is a partial cross sectional view taken along lines 16-16 of FIG. 1; and

FIGS. 17, 18 are partial cross sectional views similar to FIG. 16, illustrating the operation of the fastener feeding device for the stapler.

### DETAILED DESCRIPTION OF THE PREFERRED EMBODIMENT

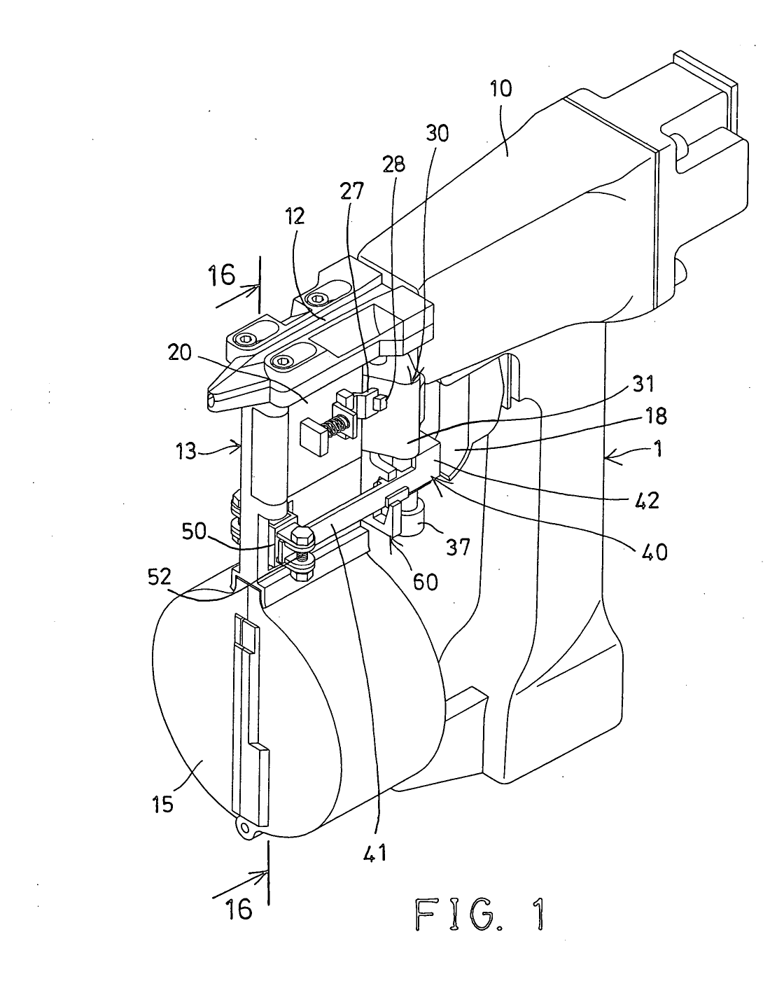

Referring to the drawings, and initially to FIGS. 1-3, a stapler 1 in accordance with the present invention comprises a gun body or housing 10 including a port 11 formed or provided in one end or rear end or lower end thereof for coupling to a hydraulic or pneumatic or pressurized reservoir and for receiving pressurized fluid or air therefrom, and including a typical nose piece 12 attached to the front and lower portion of the housing 10 for engaging with nails or staples or screws or fasteners 80 to be driven or hammered and for guiding a conventional driving device (not shown) to drive or to hammer the fasteners 80.

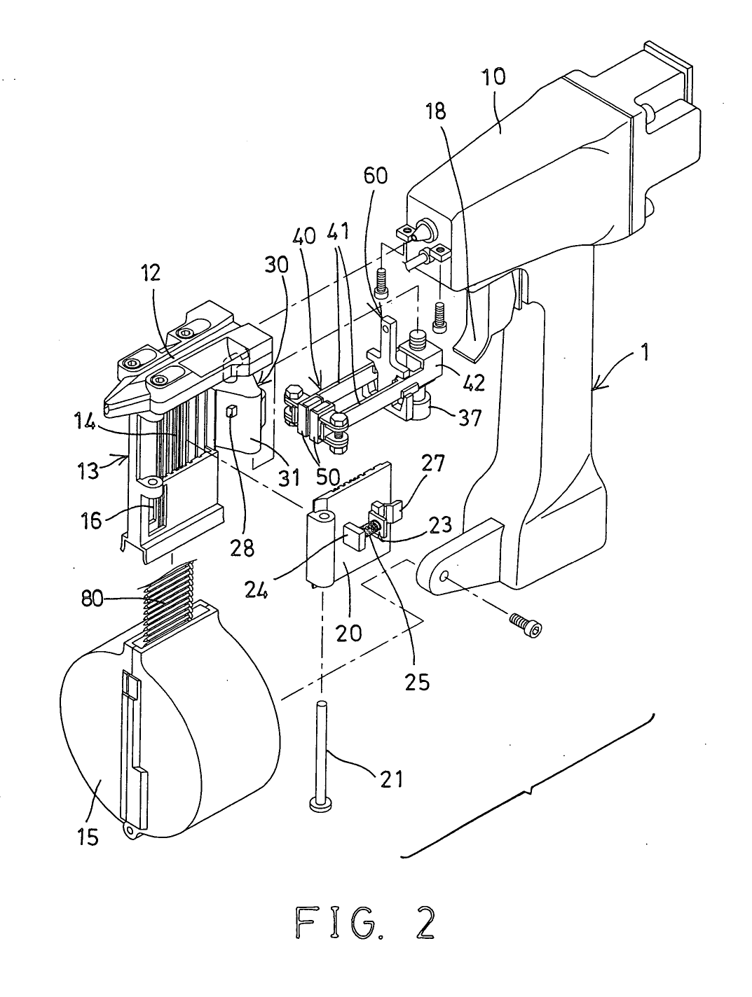

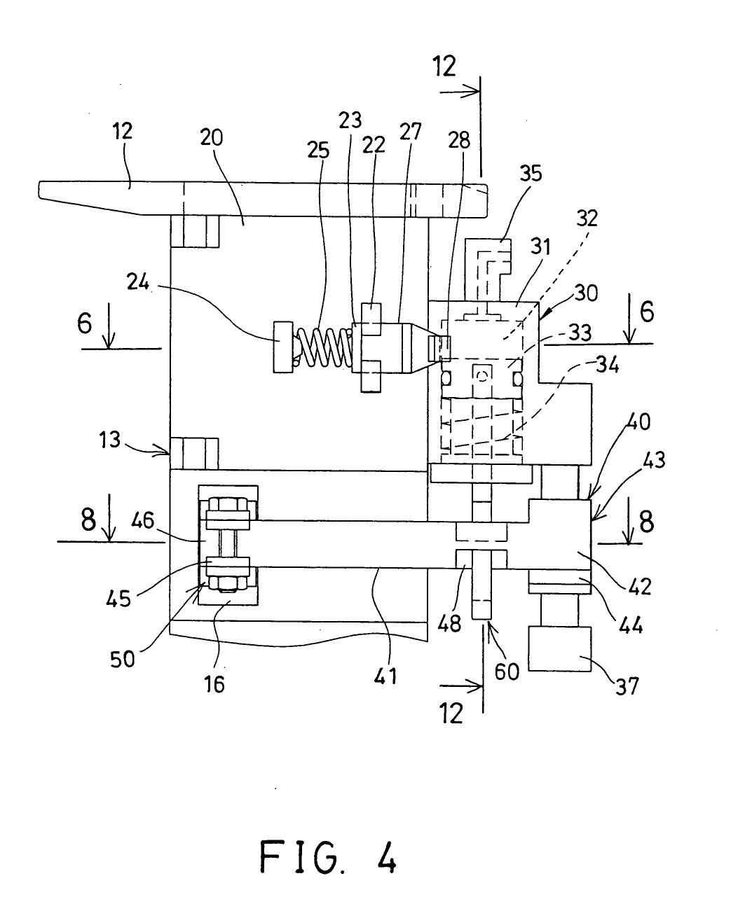

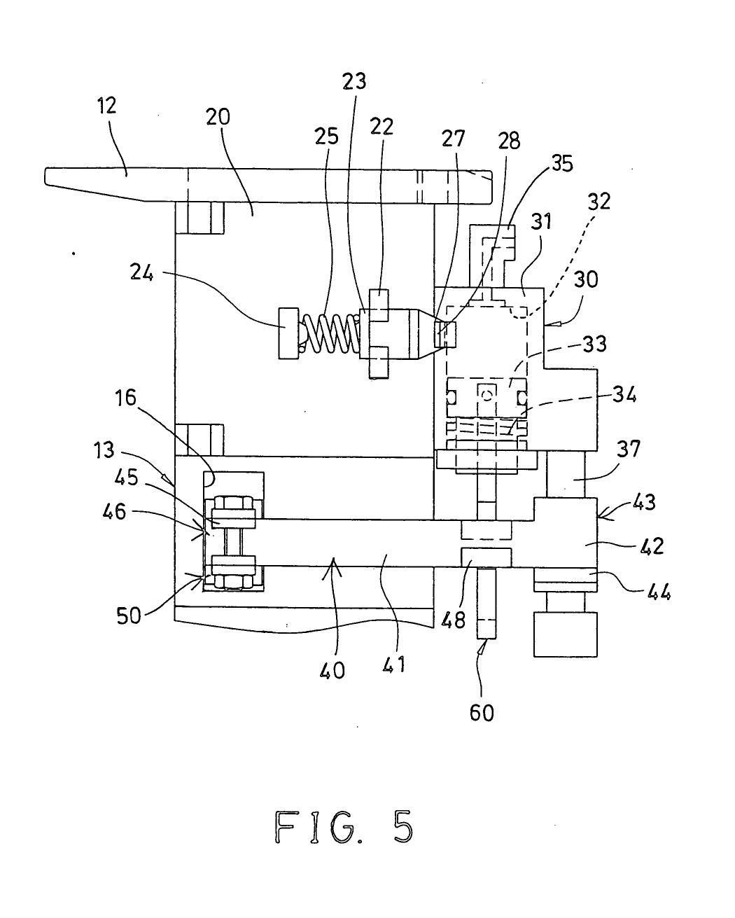

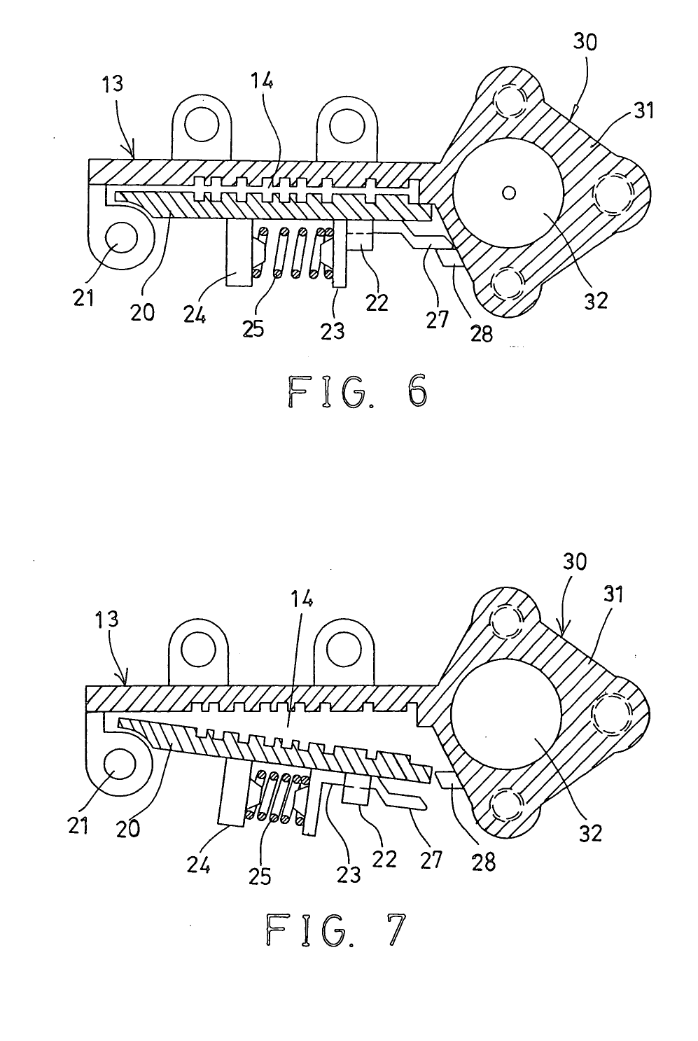

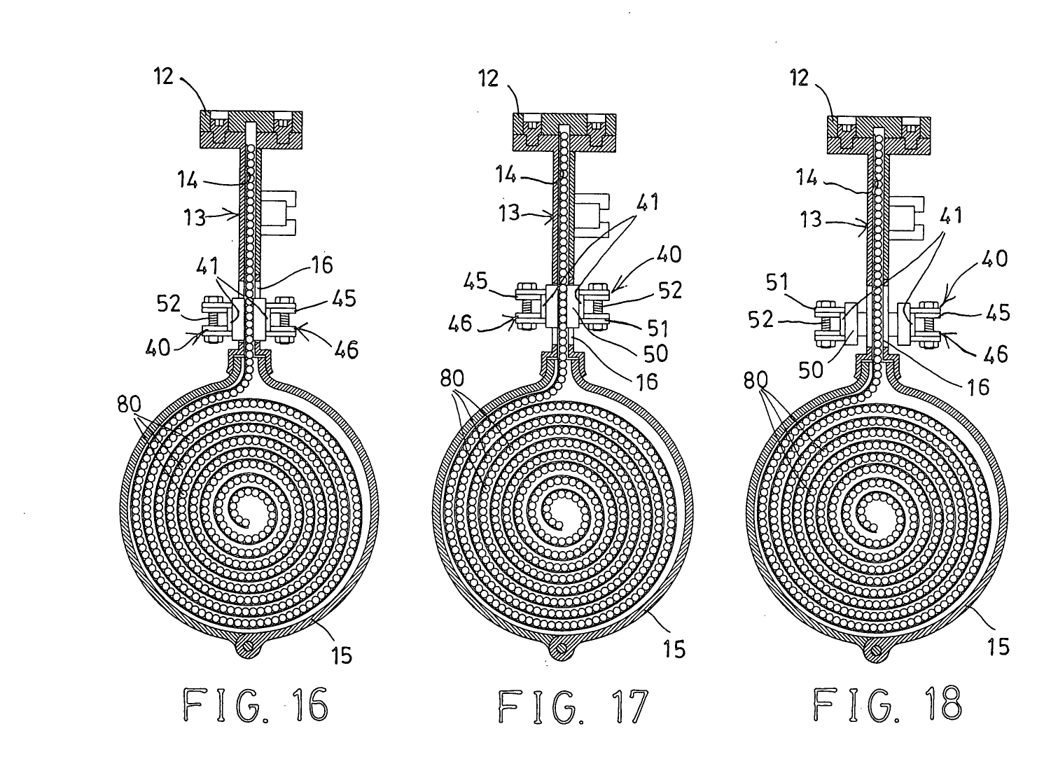

A guide device or a casing 13 is attached to the nose piece 12 and includes a guide channel 14 formed therein (FIGS. 2, 6-9 and 14-18) for receiving the fasteners 80 and for guiding the fasteners 80 toward the nose piece 12 and to be driven or hammered by the driving device (not shown). A magazine 15 is attached or coupled to the casing 13 for receiving or storing the fasteners 80 therein and for supplying the fasteners 80 into the guide channel 14 of the casing 13. The casing 13 may thus be formed or taken as a portion of the magazine 15 to receive and to guide the fasteners 80 toward the nose piece 12 best shown in FIGS. 16-18. As shown in FIGS. 1-7, the casing 13 includes a cover 20 pivotally or rotatably attached thereto with such as a pivot axle 21 (FIG. 2) for selectively opening or enclosing the guide channel 14 of the casing 13 and/or for selectively moving the jammed fasteners 80 from the casing 13, for example. The cover 20 includes a loop or retainer 22 attached thereto, a latch 23 slidably attached to the retainer 22, a peg 24 also attached to or extended from the cover 20, and a spring member 25 disposed between the latch 23 and the peg 24 for biasing a latch end or tongue 27 of the latch 23 to selectively engage with a stop 28 and to selectively lock the cover 20 to the casing 13 best shown in FIGS. 6-7.

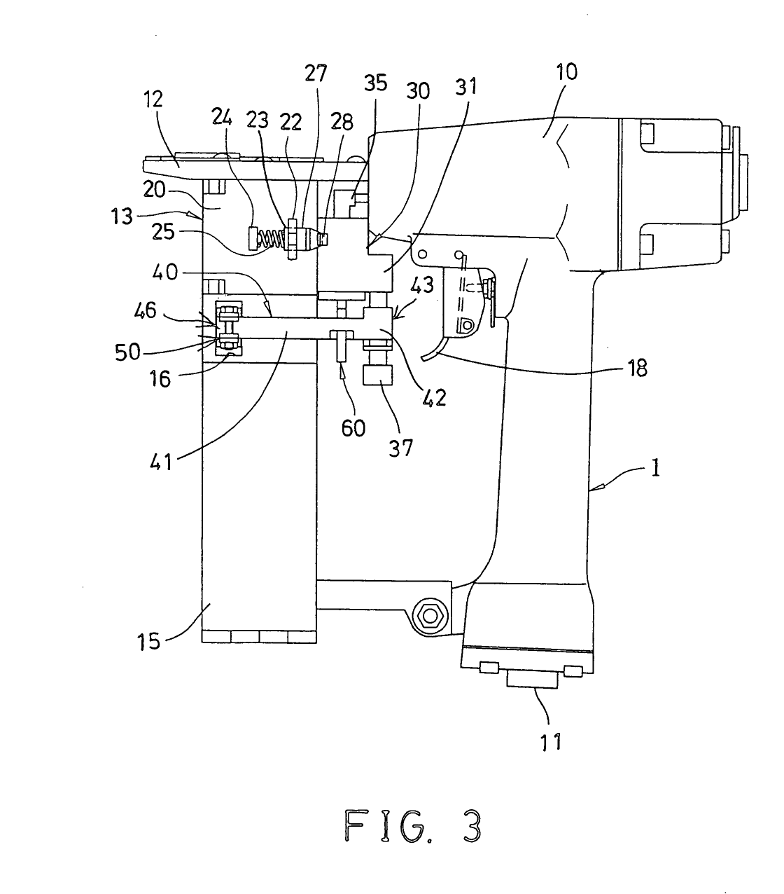

A hydraulic or pneumatic reservoir or device 30 includes a cylinder 31 attached or secured to the casing 13 and/or to the housing 10 and having a chamber 32 formed therein for slidably receiving a piston 33 therein, and having a spring member 34 received in the chamber 32 thereof for engaging with the piston 33 and biasing or recovering the piston 33, and having a mouth 35 provided thereon and coupled to or communicating with the chamber 32 thereof (FIGS. 3-5 and 12-15) for receiving a relatively smaller portion of the pressurized fluid or air from the housing 10. A post 37 is attached or secured to or extended from the cylinder 31 or the housing 10 for attaching or supporting a gripper means or device 40 thereon.

The gripper means or device 40 includes a pair of arms 41 each having a bent end panel 42 formed or provided on one end 43 thereof and rotatably and slidably attached to the post 37 and rotatabl and slidable up and down relative to the post 37, and includes a spacer 44 disposed between the end panels 42 of the arms 41 to suitably space the end panels 42 of the arms 41 from each other. The arms 41 of the gripper device 40 each includes one or more ears 45 extended from the other end portion 46 thereof, a holder 50 each having one or more ears 51 extended therefrom for pivotally or rotatably attached to the ears 45 with such as a pivot pin 52 and each provided for supporting a pad or shoe 53 therein.

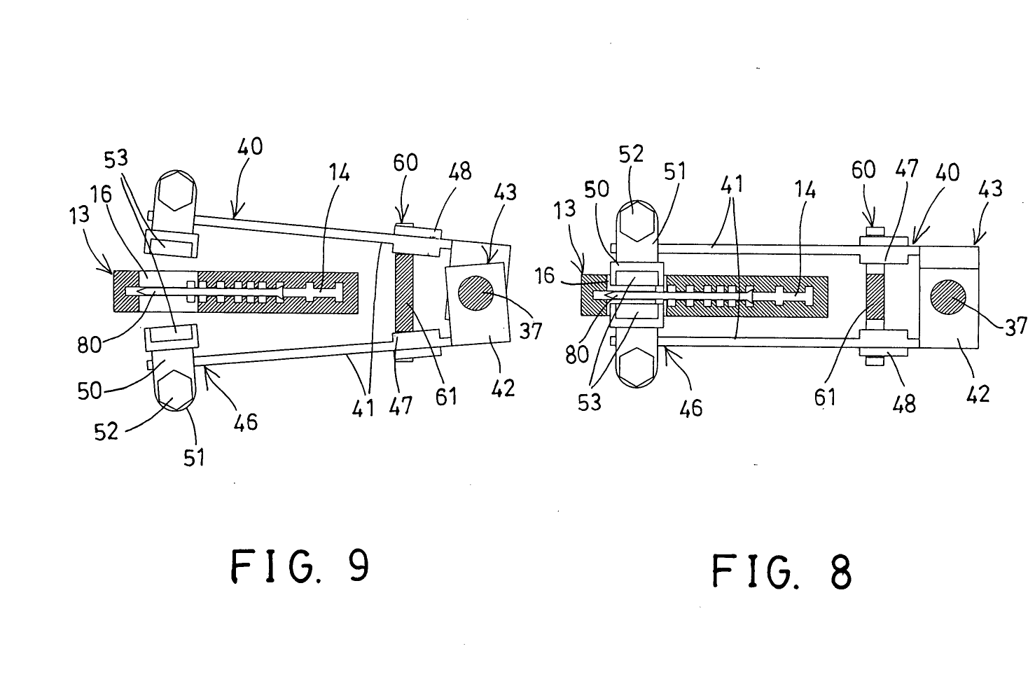

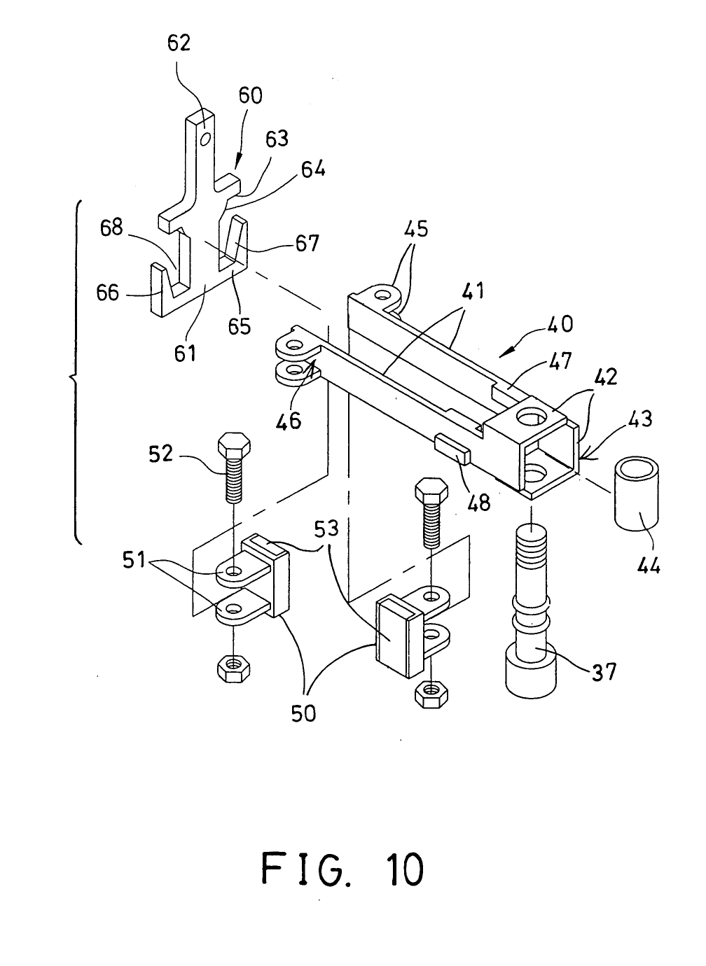

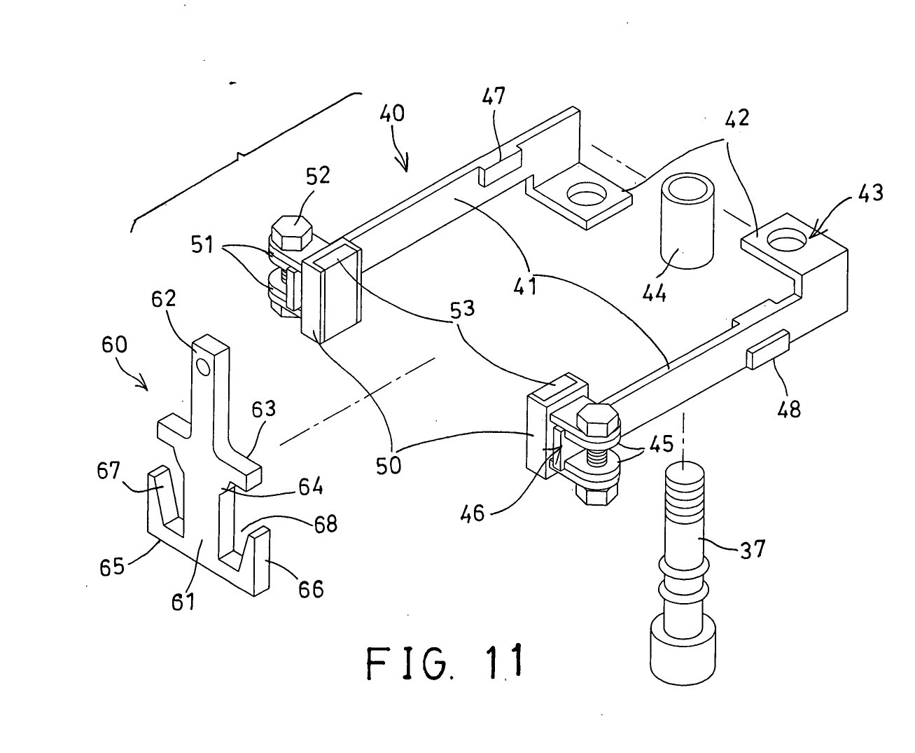

As shown in FIGS. 2-5, 8-9 and 14-18, the casing 13 includes an opening 16 formed therein and communicating with the guide channel 14 thereof for partially exposing the fasteners 80, or the fasteners 80 may pass through the opening 16 of the casing 13 gradually or in series or step by step or one by one. The holders 50 and the shoes 53 are arranged to be engaged into the opening 16 of the casing 13 for engaging with the fasteners 80 and for gripping and feeding the fasteners 80 forwardly toward the nose piece 12 step by step or one by one and for allowing the fasteners 80 to be driven or hammered by the driving device (not shown), best shown in FIGS. 8-9 and 14-18.

An actuating device 60 includes a longitudinal lever 61 having one end or front or upper end 62 secured to the piston 33 and moved in concert with the piston 33, and includes one or more, such as two fingers 63 and one or more, such as two actuators 64 extended therefrom, such as extended from the middle portion thereof, for engaging with the arms 41 respectively and for selectively spacing the arms 41 away from each other (FIG. 13), and includes a beam 65 provided or extended from the other end thereof and two blocks 66 extended from such as the end portions of the beam 65 and each having an inclined surface 67 formed therein for engaging with the arms 41 respectively and for forcing the arms 41 toward each other (FIG. 12), and preferably includes two spaces 68 formed therein or defined by the blocks 66 for receiving and/or confining the arms 41 therein.

It is preferable that the arms 41 each includes a bulge 47 laterally extended inwardly therefrom for suitably or smoothly engaging with the fingers 63 and/or the actuators 64 of the actuating device 60 respectively, and each includes a swelling 48 laterally extended outwardly therefrom for suitably or smoothly engaging with the inclined surfaces 67 of the blocks 66 of the actuating device 60 respectively. The formation or the provision of the bulges 47 and the swellings 48 on the arms 41 is arranged to determine the distance to be spaced or formed between the arms 41 and/or to determine the distance to be moved by the arms 41 along the post 37 and/or relative to the casing 13 and the magazine 15 and the cylinder 31 of the hydraulic or pneumatic device 30.

In operation, as shown in FIGS. 3-5, when the stapler 1 is operated or actuated with such as a trigger 18 (FIGS. 1-3), the conventional driving device (not shown) may be actuated or forced to drive or to hammer the fasteners 80 in the typical hammering or driving operation that will not be described in further details. At this moment, a relatively small portion of the pressurized fluid or air from the housing 10 is supplied to the chamber 32 of the cylinder 31 from the mouth 35 in order to force the piston 33 and thus the actuating device 60 to move relative to the casing 13 and the magazine 15 and the cylinder 31 of the hydraulic or pneumatic device 30 and also to move relative to the arms 41 (FIG. 13). At this moment, as best shown in FIG. 13, the fingers 63 and/or the actuators 64 of the actuating device 60 may be engaged with the arms 41, such as engaged with the bulges 47 of the arms 41 respectively to selectively space the arms 41 away from each other (FIG. 9). After the typical hammering or driving operation, the pressurized fluid or air in the chamber 32 of the cylinder 31 may be dissipated and the pressure in the chamber 32 of the cylinder 31 may be decreased, the spring member 34 may thus be engaged with the piston 33 to bias and force and move the piston 33 back to the original position or toward the mouth 35 of the cylinder 31.

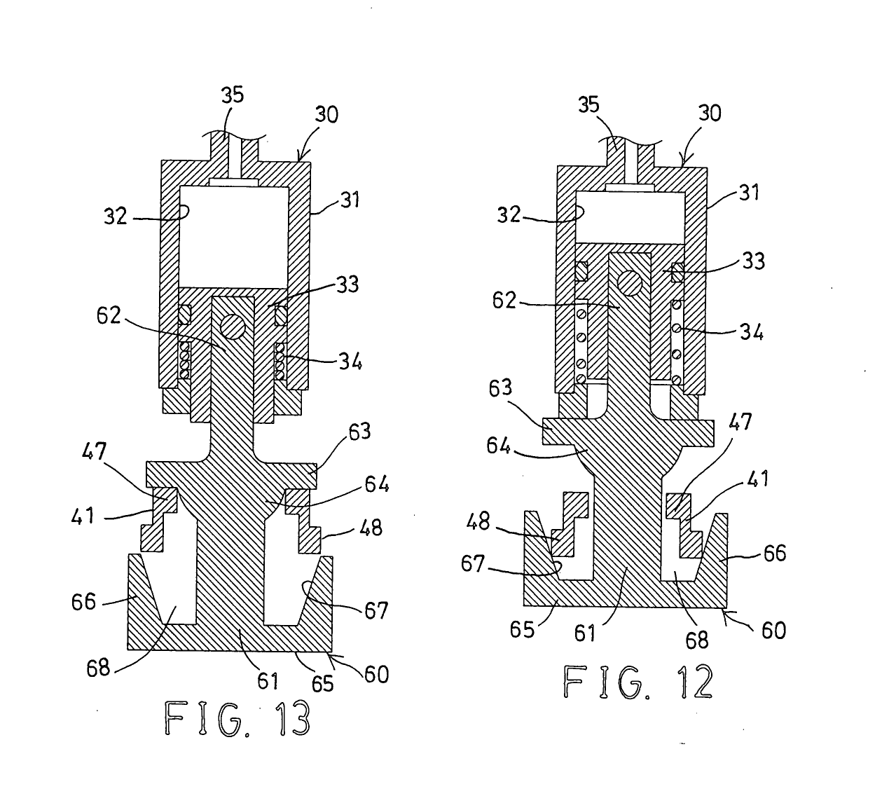

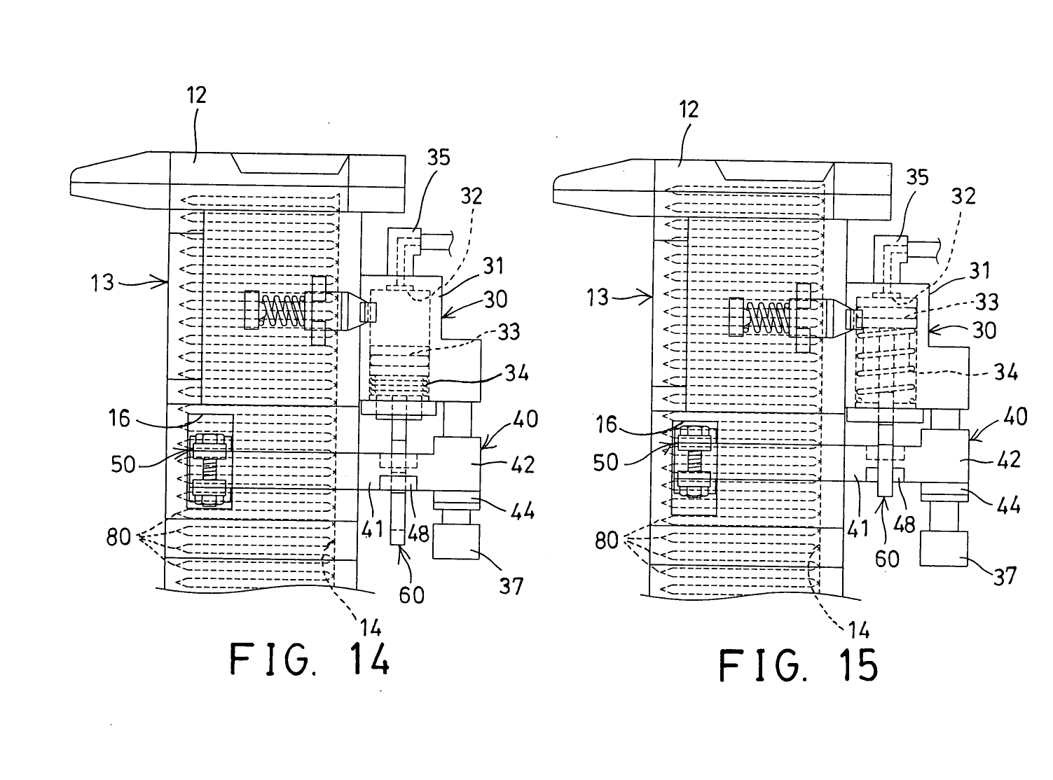

When the piston 33 is moved back toward the mouth 35 of the cylinder 31, as shown in FIG. 12, the inclined surfaces 67 of the blocks 66 may be caused to engage with the arms 41, such as engaged with the swellings 48 of the arms 41 respectively to selectively force the arms 41 to move toward each other (FIGS. 8, 12) and thus to move the holders 50 and the shoes 53 to engage with or to grip or grasp the fasteners 80. In addition, the inclined surfaces 67 of the blocks 66 are also arranged to engage with the arms 41 and to selectively and slightly move the arms 41 and thus the fasteners 80 gripped or grasped between the holders 50 and the shoes 53 toward the nose piece 12 and the driving device, such that the fasteners 80 may be suitably gripped and fed forwardly toward the nose piece 12 step by step or one by one, best shown in FIGS. 14-18, and to allow the fasteners 80 to be driven or hammered by the driving device (not shown).

It is to be noted that the arms 41 and/or the holders 50 and/or the shoes 53 may thus be formed and acted as a gripping and feeding means or device for suitably gripping and feeding the fasteners 80 forwardly toward the nose piece 12 or the driving device step by step or one by one to allow the fasteners 80 to be driven or hammered by the driving device. The fasteners 80 may include various kinds of shapes or contours or configurations, and may be the nails, the staples, the screws, the bolts, or the like and may be suitably gripped or grasped and fed forwardly by the gripping and feeding means or device.

The holders 50 and the shoes 53 may also be solidly attached to or formed integral with the arms 41 respectively. However, the pivotal engagement or attachment of the holders 50 and the shoes 53 to the arms 41 with the pivot pins 52 respectively allows the holders 50 and the shoes 53 to be slightly rotated relative to the arms 41 to allow the holders 50 and/or the shoes 53 to stably grip or grasp the fasteners 80 therebetween. Without the inclined surfaces 67 of the blocks 66, the arms 41 may also be forced or moved toward each other by such as spring members (not shown) or the like.

Accordingly, the fastener feeding device for the stapler in accordance with the present invention may be provided for engaging with and for feeding staples or nails or fasteners of the stapler step by step or one by one and for allowing the staples or nails or screws or bolts or various fasteners to be effectively driven or hammered by the stapler.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A stapler comprising:
a housing including a port for coupling to a pressurized reservoir, and including a nose piece attached thereto,
a casing attached to said nose piece and including a guide channel formed therein for receiving and for guiding fasteners toward said nose piece,
a pair of arms having a first end for engaging with the fasteners and for gripping the fasteners, and
an actuating device disposed between said arms, and said actuating device including two actuators for engaging with said arms to selectively move said first ends of said arms away from each other, and including two blocks for engaging with said arms to selectively move said first ends of said arms toward each other.

2. (canceled)

3. The stapler as claimed in claim 1, wherein said arms each includes a shoe attached to said first end thereof for engaging with the fasteners.

4. The stapler as claimed in claim 3, wherein said arms each includes a holder attached said first end thereof for holding and supporting said shoe.

5. The stapler as claimed in claim 4, wherein said holders are each pivotally attached to said arms respectively with a pivot pin.

6. The stapler as claimed in claim 3, wherein said casing includes an opening formed therein and communicating with said guide channel thereof for receiving said shoes of said arms and for allowing said shoes to selectively move toward the fasteners.

7-8. (canceled)

9. The stapler as claimed in claim 1, wherein said arms each includes a bulge extended therefrom for engaging with said actuators respectively.

10. (canceled)

11. The stapler as claimed in claim 1, wherein said actuating device includes a longitudinal lever having a beam extended therefrom and having said blocks extended from said beam for engaging with the arms.

12. The stapler as claimed in claim 11, wherein said blocks each includes an inclined surface formed therein for engaging with the arms.

13. The stapler as claimed in claim 1, wherein said arms each includes a swelling extended therefrom for engaging with said blocks respectively.

14. The stapler as claimed in claim 1, wherein said gripping and feeding means includes a cylinder having a piston slidably received therein and coupled to said actuating device for moving said actuating device relative to said arms.

15. The stapler as claimed in claim 14, wherein said cylinder includes a post attached thereto, said arms each includes a second end pivotally attached to said post.

16. The stapler as claimed in claim 15, wherein said arms each includes a bent end panel formed in said second end thereof and pivotally attached to said post, and a spacer disposed between said end panels of said arms to space said end panels of said arms from each other.

17. The stapler as claimed in claim 1, wherein said casing includes a cover pivotally attached thereto with a pivot axle for selectively opening and enclosing said guide channel of said casing.

18. The stapler as claimed in claim 17, wherein said cover includes a spring-biased latch for selectively locking said cover to said casing.

19. The stapler as claimed in claim 18, wherein said cover includes a retainer attached thereto for slidably attaching said latch, and a peg attached thereto, and a spring member disposed between said latch and said peg for biasing a tongue of said latch to selectively engage with a stop.
